(19) United States
(12) Patent Application Publication
(10) Pub. No.: US 2026/0302531 A1
(43) Pub. Date: Oct. 1, 2026

(54) SECONDARY BATTERY AND ELECTRONIC DEVICE

(71) Applicant: Ningde Amperex Technology Limited, Ningde (CN)

(72) Inventor: Congcong WEI, Ningde (CN)

(73) Assignee: Ningde Amperex Technology Limited, Ningde (CN)

(21) Appl. No.: 19/632,456

(22) Filed: Mar. 30, 2026

(30) Foreign Application Priority Data
Mar. 31, 2025 (CN) 202510397332.6

(51) Int. Cl. H01M 50/426; H01M 4/02; H01M 4/36; H01M 4/525; H01M 10/0525; H01M 50/434; H01M 50/449; H01M 50/489

(52) U.S. Cl. CPC H01M 50/426; H01M 4/366; H01M 4/525; H01M 10/0525; H01M 50/434; H01M 50/449; H01M 50/489; H01M 2004/021; H01M 2004/028

(57) ABSTRACT

A secondary battery includes a positive electrode plate and a separator. The positive electrode plate includes a positive current collector and a positive electrode material layer. The positive electrode material layer includes a first material layer and a second material layer. The positive electrode material layer includes a first region, an interface region, and a second region along a direction from the first material layer to the second material layer. An average particle diameter of active material particles in the first region is D1, 3 μm≤D1≤5 μm. An average particle diameter of active material particles in the second region is D2, 9 μm≤D2≤40 μm. An average particle diameter of active material particles in the interface region is D3, 6 μm≤D3≤22 μm. The separator includes an adhesive layer. The adhesive layer is in contact with the second material layer.

### CROSS-REFERENCE TO RELATED APPLICATION

This application claims priority to the Chinese Patent Application Serial No. 202510397332.6 filed on Mar. 31, 2025, the content of which is incorporated herein by reference in its entirety.

### TECHNICAL FIELD

This application relates to the field of electrochemical technology, and in particular, to a secondary battery and an electronic device.

### BACKGROUND

With the rapid development of renewable energy and electric transportation, secondary batteries are widely used in modern life and industry. Secondary batteries provide efficient and stable energy support for portable electronic devices and new energy technologies ranging from smartphones and laptops to electric vehicles and energy storage systems.

However, residual alkaline substances usually exist in a positive active material of a secondary battery prepared by a current manufacturing process, and are prone to react with an adhesive layer in a separator, thereby affecting the effect of adhesion between the separator and a positive electrode plate. Consequently, the adhesion between the positive electrode material layer and the separator is insufficient, and the positive electrode plate is prone to detach from the separator. This not only causes deformation of the secondary battery and affects cycle performance but also results in lithium plating and black spots and poses a risk that lithium dendrites puncture the separator and cause a short circuit, thereby impairing the safety performance of the secondary battery. Therefore, increasing the peel strength between the positive electrode plate and the separator to improve the cycle performance of the secondary battery is a pressing technical challenge.

### SUMMARY

An objective of this application is to provide a secondary battery and an electronic device to improve the cycle performance and safety performance of the secondary battery.

It is noted that in the description hereof, this application is construed by using a lithium-ion battery as an example of the secondary battery, but the secondary battery of this application is not limited to the lithium-ion battery. Specific technical solutions are as follows:

A first aspect of this application provides a secondary battery. The secondary battery includes a positive electrode plate and a separator. The positive electrode plate includes a positive current collector and a positive electrode material layer disposed on at least one surface of the positive current collector. The positive electrode material layer includes a first material layer and a second material layer. The first material layer is located between the positive current collector and the second material layer. A contact surface between the first material layer and the second material layer defines an interface. An interface region includes: a region extending 5 μm from the interface along a direction from the first material layer to the second material layer, and a region extending 5 μm from the interface along a direction from the second material layer to the first material layer. A region other than the interface region in the first material layer is a first region, and a region other than the interface region in the second material layer is a second region. An average particle diameter of active material particles in the first region is D1, 3 μm≤D1≤5 μm. An average particle diameter of active material particles in the second region is D2, 9 μm≤D2≤40 μm. An average particle diameter of active material particles in the interface region is D3, 6 μm≤D3≤22 μm. The separator includes a base film and adhesive layers. The adhesive layers are disposed on at least one surface of the base film in a thickness direction of the base film. At least one of the adhesive layers is in contact with the second material layer. The above configuration achieves a good effect of adhesion between the positive electrode plate and the separator, and reserves a relatively large number of paths for the transport of active ions, thereby reducing the deformation of the secondary battery and the occurrence of lithium plating and black spots, and contributing to a good trade-off between the safety performance, kinetic performance, and cycle performance of the secondary battery.

In some embodiments of this application, peel strength between the second material layer and the separator is F, 1 N/m≤F≤20 N/m. In some embodiments of this application, 3 N/m≤F≤15 N/m. When the peel strength F between the second material layer and the separator falls within the above range, the effect of adhesion between the positive electrode plate and the separator is good, and a relatively large number of paths are reserved for the transport of active ions, thereby reducing the deformation of the secondary battery and the occurrence of lithium plating and black spots, and improving the cycle performance and safety performance of the secondary battery while achieving desirable kinetic performance.

In some embodiments of this application, the adhesive layer includes one or more selected from the group consisting of polyacrylate, oil-based polyvinylidene fluoride, water-based polyvinylidene fluoride, and poly(vinylidene fluoride-co-hexafluoropropylene). By selecting the above binders of high adhesiveness, this application further increases the peel strength between the second material layer and the separator, thereby reducing the deformation of the secondary battery and the occurrence of lithium plating and black spots, and improving the cycle performance and safety performance of the secondary battery.

In some embodiments of this application, based on an area of the separator, an area fraction of the adhesive layer is b, 10%≤b×100%≤70%. In some embodiments of this application, 30%≤b×100%≤50%. The area fraction of the adhesive layer falling within the above range can reduce the probability of detachment of the positive electrode plate from the separator without exacerbating the internal resistance of the positive electrode plate, thereby improving the safety performance and cycle performance of the secondary battery while achieving desirable kinetic performance.

In some embodiments of this application, the second material layer includes a second positive active material. A specific surface area of the second positive active material is S, 0.07 m²/g≤S≤0.3 m²/g. In some embodiments of this application, 0.1 m²/g≤S≤0.25 m²/g. In some embodiments of this application, 0.12 m²/g≤S≤0.2 m²/g. By controlling the value of S to fall within the above range, this application reduces the deformation of the secondary battery and the occurrence of lithium plating and black spots, and improves the cycle performance and safety performance of the secondary battery. In addition, the specific surface area falling within the above range also shortens the transport path of active ions such as lithium ions, thereby reducing the internal resistance of the positive electrode plate and improving the kinetic performance of the secondary battery.

In some embodiments of this application, a heat shrink ratio of the separator is h, 1%≤h≤15%. When the heat shrink ratio h of the separator falls within the above range, the separator exhibits superior high-temperature resistance and is less prone to excessive shrinkage in high-temperature environments, thereby reducing the probability of short-circuiting of the secondary battery caused by shrinkage of the separator, and improving the safety performance of the secondary battery.

In some embodiments of this application, the separator further includes a ceramic layer. The ceramic layer is located between the adhesive layer and the base film. A total coating amount of the adhesive layer and the ceramic layer is a, 7.7 mg/5000 mm²≤a≤26 mg/5000 mm². By controlling the total coating amount a of the adhesive layer and the ceramic layer to fall within the above range, this application further improves the thermal stability and mechanical strength of the separator, thereby further improving the safety performance of the secondary battery.

In some embodiments of this application, a thickness of the ceramic layer is d1, 0.5 μm≤d1≤4 μm. A thickness of the adhesive layer is d2, 0.2 μm≤d2≤3 μm. By controlling d1 and d2 to fall within the above ranges, this application not only improves the thermal stability and mechanical strength of the separator, but also helps control the thickness of the secondary battery to fall within an appropriate range, thereby improving the safety performance of the secondary battery while achieving a desirable energy density.

In some embodiments of this application, the adhesive layer further includes a ceramic material. A coating amount of the adhesive layer is c, 3 mg/5000 mm²≤c≤12 mg/5000 mm². By controlling the value of c to fall within the above range, this application improves thermal stability and mechanical strength of the separator while achieving appropriate adhesiveness of the separator, thereby improving the peel strength between the positive electrode plate and the separator, and consequently improving the cycle performance and safety performance of the secondary battery.

In some embodiments of this application, based on a mass of the adhesive layer, a mass percent w of the ceramic material is 40% to 70%. By controlling the mass percent w of the ceramic material to fall within the above range, this application further balances the adhesiveness, thermal stability, and mechanical strength of the secondary battery, thereby further improving the cycle performance and safety performance of the secondary battery.

In some embodiments of this application, a thickness of the adhesive layer is d3, 1 μm≤d3≤4 μm. By controlling d3 to fall within the above range, this application improves the thermal stability and mechanical strength of the separator, and also keeps the thickness of the secondary battery within an appropriate range, thereby improving the safety performance of the secondary battery while achieving a desirable energy density.

In some embodiments of this application, the first material layer includes a first positive active material. The second material layer includes a second positive active material. The first positive active material and the second positive active material each independently include one or more selected from the group consisting of lithium cobalt oxide, lithium manganese oxide, lithium nickel cobalt manganese oxide, and lithium nickel cobalt aluminum oxide. The average particle diameter of the above positive active materials is highly matching, and can be well controlled to meet the ranges of D1, D2, and D3 described above, thereby further improving in the cycle performance, kinetic performance, and safety performance of the secondary battery.

In some embodiments of this application, the first positive active material includes at least one of lithium nickel cobalt manganese oxide or lithium nickel cobalt aluminum oxide. In some embodiments of this application, the first positive active material includes lithium nickel cobalt manganese oxide. In some embodiments of this application, the second positive active material includes at least one of lithium cobalt oxide or lithium manganese oxide. In some embodiments of this application, the second positive active material includes lithium cobalt oxide. In this way, the first positive active material and the second positive active material coordinate with each other, and meet the ranges of the average particle diameters D1, D2, and D3 specified above, thereby further balancing and improving the kinetic performance, cycle performance, energy density, and cost of the secondary battery.

A second aspect of this application provides an electronic device. The electronic device includes the secondary battery disclosed in any one of the preceding embodiments.

Some of the beneficial effects of this application are as follows:

This application provides a secondary battery and an electronic device. The secondary battery includes a positive electrode plate and a separator. The positive electrode plate includes a positive current collector and a positive electrode material layer disposed on at least one surface of the positive current collector. The positive electrode material layer includes a first material layer and a second material layer. The first material layer is located between the positive current collector and the second material layer. A contact surface between the first material layer and the second material layer defines an interface. An interface region includes: a region extending 5 μm from the interface along a direction from the first material layer to the second material layer, and a region extending 5 μm from the interface along a direction from the second material layer to the first material layer. A region other than the interface region in the first material layer is a first region, and a region other than the interface region in the second material layer is a second region. An average particle diameter of active material particles in the first region is D1, 3 μm≤D1≤5 μm. An average particle diameter of active material particles in the second region is D2, 9 μm≤D2≤40 μm. An average particle diameter of active material particles in the interface region is D3, 6 μm≤D3≤22 μm. The separator includes a base film and adhesive layers. The adhesive layers are disposed on at least one surface of the base film in a thickness direction of the base film. At least one of the adhesive layers is in contact with the second material layer. By setting the average particle diameters of the active materials in the first region, the second region, and the interface region differently, this application increases the peel strength between the first material layer and the positive current collector, and leaves appropriate voids in the second material layer so that the binder particles of the adjacent adhesive layer disposed on the base film can swell and penetrate into the voids during subsequent chemical formation and hot-pressing of the secondary battery, thereby increasing the peel strength between the second material layer and the separator. Therefore, through the above configuration, this application enhances the effect of adhesion between the positive electrode plate and the separator in the secondary battery, alleviates the lithium plating, and improves the cycle performance and safety performance of the secondary battery. In addition, the first material layer with an average particle diameter falling within the above range can contribute to desirable kinetic performance.

Definitely, a single product or method in which the technical solution of this application is implemented does not necessarily achieve all of the above advantages concurrently.

### BRIEF DESCRIPTION OF DRAWINGS

To describe the technical solutions in some embodiments of this application more clearly, the following outlines the drawings to be used in the description of the embodiments. Evidently, the drawings outlined below merely illustrate some embodiments of this application, and a person of ordinary skill in the art may derive other embodiments based on the drawings.

FIG. 1 is a schematic diagram of a positive electrode plate viewed along a thickness direction of the positive electrode plate according to an embodiment of this application;

FIG. 2 is a schematic diagram of a positive electrode plate viewed along a thickness direction of the positive electrode plate according to another embodiment of this application;

FIG. 3 is a scanning electron microscope image of a first material layer according to Embodiment 1-1;

FIG. 4 is a scanning electron microscope image of a second material layer according to Embodiment 1-1; and

FIG. 5 is a scanning electron microscope image of a structure with an adhesive layer disposed on a surface of a ceramic layer according to Embodiment 2-11.

### DETAILED DESCRIPTION

The following describes the technical solutions in this application clearly and comprehensively with reference to the embodiments and accompanying drawings hereof. Evidently, the described embodiments are merely a part of but not all of the embodiments of this application. All other embodiments derived by a person skilled in the art based on this application still fall within the protection scope of this application.

It is noted that in specific embodiments of this application, this application is construed by using a lithium-ion battery as an example of the secondary battery, but the secondary battery of this application is not limited to the lithium-ion battery. Specific technical solutions are as follows:

To enhance the effect of adhesion between the separator and the positive electrode plate and reduce deformation of the secondary battery caused by detachment of the positive electrode plate from the separator, and to improve cycle performance, existing main approaches are to increase the hot-pressing pressure or temperature during the chemical formation stage. However, increasing the hot-pressing pressure is prone to cause excessively small voids between the active material particles in the positive electrode material layer. The excessively small voids make it difficult to store enough electrolyte solution. During cycling of the secondary battery, problems such as lithium plating and black spots are prone to occur due to shortage of electrolyte solution and affect cycle performance. Increasing the hot-pressing temperature are also prone to cause an increase in side reactions, deplete the electrolyte solution, and affect the cycle capacity retention rate of the secondary battery.

In view of the above problems, this application provides a secondary battery and an electronic device to favorably improve the adhesiveness between the positive electrode plate and the separator and consequently reduce the occurrence of lithium plating and black spots and the deformation of the secondary battery, and therefore, improve cycle performance.

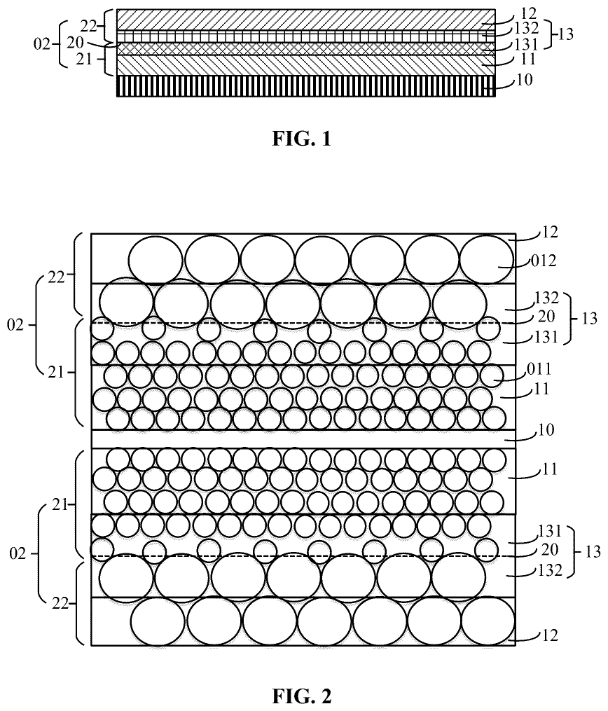

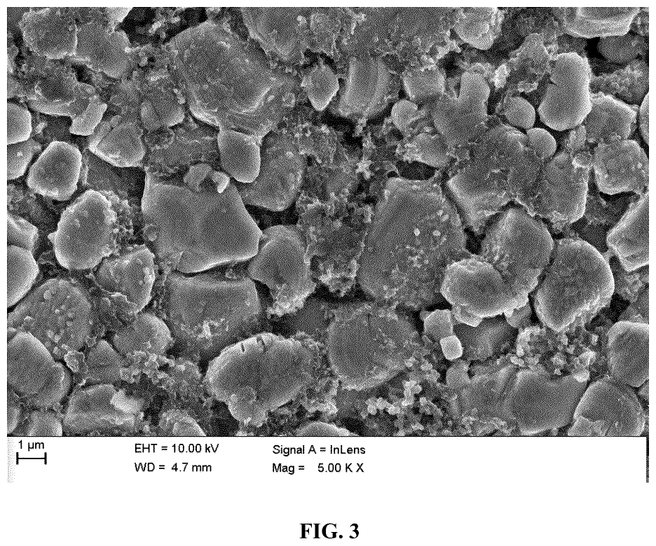

A first aspect of this application provides a secondary battery. The secondary battery includes a positive electrode plate and a separator. The positive electrode plate includes a positive current collector and a positive electrode material layer disposed on at least one surface of the positive current collector. The positive electrode material layer includes a first material layer and a second material layer. The first material layer is located between the positive current collector and the second material layer. In some embodiments of this application, as shown in FIG. 1, the positive electrode material layer 02 is disposed on one surface of the positive current collector 10. A contact surface between the first material layer 21 and the second material layer 22 defines an interface 20. An interface region 13 includes: a second subregion 132 extending 5 μm from the interface along a direction from the first material layer 21 to the second material layer 22, and a first subregion 131 extending 5 μm from the interface 20 along a direction from the second material layer 22 to the first material layer 21. A region other than the first subregion 131 in the first material layer 21 is a first region 11. A region other than the second subregion 132 in the second material layer 22 is a second region 12. In some embodiments of this application, as shown in FIG. 2, the positive electrode material layer 02 is disposed on two surfaces of the positive current collector 10. A contact surface between the first material layer 21 and the second material layer 22 defines an interface 20. An interface region 13 includes: a second subregion 132 extending 5 μm from the interface along a direction from the first material layer 21 to the second material layer 22, and a first subregion 131 extending 5 μm from the interface 20 along a direction from the second material layer 22 to the first material layer 21. A region other than the first subregion 131 in the first material layer 21 is a first region 11. A region other than the second subregion 132 in the second material layer 22 is a second region 12. The first region 11 includes a first positive active material particle 011. The second region 12 includes a second positive active material particle 012. The interface region 13 includes the first positive active material particle 011 and the second positive active material particle 012. An average particle diameter of active material particles in the first region is D1, 3 μm≤D1≤5 μm. An average particle diameter of active material particles in the second region is D2, 9 μm≤D2≤40 μm. An average particle diameter of active material particles in the interface region is D3, 6 μm≤D3≤22 μm. In this application, the separator includes a base film and adhesive layers. Each adhesive layer includes a separator binder. The adhesive layer is disposed on at least one surface of the base film in a thickness direction of the base film. At least one of the adhesive layers is in contact with the second material layer. By setting the average particle diameters of the active materials in the first region, the second region, and the interface region differently, this application makes the average particle diameter range of the active material particles in the third region provide such convenience that the binder particles of the adhesive layer disposed on the base film can conveniently swell and penetrate into the voids during subsequent chemical formation and hot-pressing of the secondary battery, thereby increasing the peel strength between the positive electrode plate and the separator. Therefore, the positive electrode plate is not prone to detach from the separator, thereby reducing the occurrence of lithium plating and black spots, and reducing the deformation of the secondary battery, and consequently improving cycle performance.

In this application, the average particle diameter of the active material particles in the first region is D1, 3 μm≤D1≤5 μm. For example, D1 may be 3 μm, 3.1 μm, 3.2 μm, 3.3 μm, 3.4 μm, 3.5 μm, 3.6 μm, 3.7 μm, 3.8 μm, 3.9 μm, 4 μm, 4.1 μm, 4.2 μm, 4.3 μm, 4.4 μm, 4.5 μm, 4.6 μm, 4.7 μm, 4.8 μm, 4.9 μm, 5 μm, or a value falling within a range formed by any two thereof. When the active material particles are excessively small, for example, when D1 is less than 3 μm, the active material particles are prone to agglomerate during the preparation of the positive electrode plate, thereby increasing the internal resistance of the positive electrode plate and consequently affecting the C-rate performance and cycle performance of the secondary battery. In addition, an excessively small average particle diameter increases side reactions and depletes the electrolyte solution, thereby affecting the energy density and cycle performance of the secondary battery. When the active material particles are excessively large, for example, when D1 is greater than 5 μm, the amount of active material per unit positive electrode plate decreases, resulting in a lower energy density of the secondary battery. Therefore, by controlling D1 to fall within the above range, this application achieves a good trade-off between the energy density, kinetic performance, and cycle performance of the secondary battery. The average particle diameter of active material particles in the second region is D2, 9 μm≤D2≤40 μm. For example, D2 may be 9 μm, 10 μm, 12 μm, 13 μm, 13.2 μm, 13.5 μm, 13.8 μm, 14 μm, 14.2 μm, 14.5 μm, 14.8 μm, 15 μm, 15.2 μm, 15.5 μm, 15.8 μm, 16μ, 16.2μ, 16.5 μm, 16.8 μm, 17 μm, 17.2μ, 17.5 μm, 17.8 μm, 18 μm, 20 μm, 22 μm, 24 μm, 26 μm, 28 μm, 30 μm, 32 μm, 34 μm, 36 μm, 38 μm, 40 μm, or a value falling within a range formed by any two thereof. When D2 is excessively small, for example, when D2 is less than 13 μm, the number of voids between the active material particles is insufficient, and makes it inconvenient for the separator binder to swell and penetrate into the voids during chemical formation and hot pressing, thereby affecting the effect of adhesion between the positive electrode plate and the separator, making the secondary battery prone to deform, resulting in lithium plating and black spots, and affecting the cycle performance and safety performance of the secondary battery. When D2 is excessively large, for example, when D2 is greater than 18 μm, the amount of active material per unit positive electrode plate is reduced, the utilization rate of the active material decreases, and the gravimetric capacity of the positive active material is reduced. In addition, this makes the transport path of the active ions excessively long and increases the impedance of the positive electrode plate, and the resulting secondary battery exhibits a relatively low energy density and inferior kinetic performance.

The average particle diameter of active material particles in the interface region is D3, 6 μm≤D3≤22 μm. For example, D3 may be 6 μm, 7 μm, 8.2 μm, 8.4 μm, 8.6 μm, 8.8 μm, 9 μm, 9.2 μm, 9.4 μm, 9.6 μm, 9.8 μm, 10 μm, 10.2 μm, 10.4 μm, 10.6 μm, 10.8 μm, 11 μm, 11.2 μm, 11.4 μm, 11.6 μm, 11.8 μm, 12 μm, 13 μm, 14 μm, 15 μm, 16 μm, 17 μm, 18 μm, 19 μm, 20 μm, 21 μm, 22 μm, or a value falling within a range formed by any two thereof. Therefore, by controlling D1, D2, and D3 to fall within the above range, this application achieves a good trade-off between the safety performance, kinetic performance, and cycle performance of the secondary battery.

In this application, the first region includes a first positive active material, the second region includes a second positive active material, and the particles of the first positive active material and the second positive active material usually do not change significantly during the preparation of the secondary battery. Therefore, in this application, the average particle diameter of the active material in the first region is also the average particle diameter of the first positive active material. Similarly, the average particle diameter of the active material in the second region is also the average particle diameter of the second positive active material.

In a preparation process of the positive electrode plate, a first material layer is first disposed on the surface of the positive current collector, and then a second material layer is disposed on the surface of the first material layer. Because the first material layer and the second material layer usually employ similar solvent systems, after the slurry of the second material layer is applied, the region of the first material layer that lies far away from the surface of the positive current collector becomes partially dissolved and fuses with the slurry of the second material layer, thereby forming an interface region after being dried. Therefore, the average particle diameter of the active material particles in the interface region falls between the average particle diameter of the active material particles in the first region and the average particle diameter of the active material particles in the second region.

In some embodiments of this application, the second material layer includes a second positive active material. A specific surface area of the second positive active material is S, 0.07 m²/g≤S≤0.3 m²/g. In some embodiments of this application, 0.1 m²/g≤S≤0.25 m²/g. In some embodiments of this application, 0.12 m²/g≤S≤0.2 m²/g. For example, S may be 0.07 m²/g, 0.08 m²/g, 0.09 m²/g, 0.1 m²/g, 0.11 m²/g, 0.12 m²/g, 0.14 m²/g, 0.16 m²/g, 0.18 m²/g, 0.2 m²/g, 0.22 m²/g, 0.24 m²/g, 0.26 m²/g, 0.28 m²/g, 0.3 m²/g, or a value falling within a range formed by any two thereof. By controlling S to fall within the above range, in a subsequent chemical formation and hot pressing stage during preparation of the secondary battery, it is convenient for the second material layer to contact the binder when the separator binder swells and penetrates into the voids between the positive active material particles in the second material layer, thereby improving the effect of adhesion between the positive electrode plate and the separator, consequently reducing deformation of the secondary battery and the occurrence of lithium plating and black spots of the secondary battery, and improving the cycle performance and safety performance of the secondary battery. In addition, the specific surface area falling within the above range also facilitates contact between the second material layer and the electrolyte solution, and shortens the transport path of active ions such as lithium ions, thereby reducing the internal resistance of the positive electrode plate and improving the kinetic performance of the secondary battery. The second positive active materials of different specific surface areas may be purchased and may be tested and calculated using a gas adsorption method (BET method). A person skilled in the art may select the second positive active material of a corresponding specific surface area as needed.

In some embodiments of this application, the first material layer includes a first positive active material. The second material layer includes a second positive active material.

The first positive active material and the second positive active material each independently include one or more selected from the group consisting of lithium cobalt oxide, lithium manganese oxide, lithium nickel cobalt manganese oxide, and lithium nickel cobalt aluminum oxide. The average particle diameter of the above positive active materials is highly matching, and can be well controlled to meet the ranges of D1, D2, and D3 described above, thereby further improving in the cycle performance, kinetic performance, and safety performance of the secondary battery.

In some embodiments of this application, the first positive active material includes at least one of lithium nickel cobalt manganese oxide or lithium nickel cobalt aluminum oxide. In some embodiments of this application, the first positive active material includes lithium nickel cobalt manganese oxide. The second positive active material includes at least one of lithium cobalt oxide or lithium manganese oxide. In some embodiments of this application, the second positive active material includes lithium cobalt oxide. The first positive active material exhibits relatively high energy density, safety performance, and cycle performance, but is costly. By being used together with lithium cobalt oxide, the first positive active material further increases the energy density of the secondary battery. By being used together with lithium manganese oxide, the first positive active material reduces the cost of the secondary battery. In this way, the first positive active material and the second positive active material coordinate with each other, and meet the ranges of the average particle diameters D1, D2, and D3 specified above, thereby further balancing and improving the kinetic performance, cycle performance, energy density, and cost of the secondary battery.

In some embodiments of this application, peel strength between the second material layer and the separator is F, 1 N/m≤F≤20 N/m. In some embodiments of this application, 3 N/m≤F≤15 N/m. For example, F may be 1 N/m, 2 N/m, 3 N/m, 4 N/m, 5 N/m, 6 N/m, 7 N/m, 8 N/m, 9 N/m, 10 N/m, 11 N/m, 12 N/m, 13 N/m, 14 N/m, 15 N/m, 16 N/m, 17 N/m, 18 N/m, 19 N/m, 20 N/m, or a value falling within a range formed by any two thereof. When the peel strength F between the second material layer and the separator falls within the above range, the effect of adhesion between the positive electrode plate and the separator is good, and a relatively large number of paths are reserved for the transport of active ions, thereby reducing the deformation of the secondary battery and the occurrence of lithium plating and black spots, and improving the cycle performance and safety performance of the secondary battery while achieving desirable kinetic performance.

In some embodiments of this application, the separator binder in the adhesive layer includes one or more selected from the group consisting of polyacrylate, oil-based polyvinylidene fluoride, water-based polyvinylidene fluoride, and poly(vinylidene fluoride-co-hexafluoropropylene). By selecting the above binders of high adhesiveness, this application further increases the peel strength between the second material layer and the separator, thereby reducing the probability of detachment of the positive electrode plate from the separator, and consequently reducing the deformation of the secondary battery and the occurrence of lithium plating and black spots, and improving the cycle performance and safety performance of the secondary battery.

In some embodiments of this application, based on an area of the separator, an area fraction of the adhesive layer is b, 10%≤b×100%≤70%. In some embodiments of this application, 30%≤b×100%≤50%. For example, b×100% may be 10%, 12%, 15%, 17%, 20%, 22%, 25%, 28%, 30%, 32%, 35%, 38%, 40%, 42%, 45%, 48%, 50%, 52%, 55%, 58%, 60%, 62%, 65%, 68%, 70%, or a value falling within a range formed by any two thereof. The area fraction of the adhesive layer falling within the above range not only reserves channels for ion transport, but also improves adhesion between the second material layer and the separator, and therefore, can reduce the probability of detachment of the positive electrode plate from the separator without exacerbating the internal resistance of the positive electrode plate, thereby improving the safety performance and cycle performance of the secondary battery while achieving desirable kinetic performance.

In some embodiments of this application, a heat shrink ratio of the separator is h, 1%≤h≤15%. For example, the value of h may be 1%, 1.5%, 2%, 2.5%, 3%, 3.5%, 4%, 4.5%, 5%, 5.5%, 6%, 6.5%, 7%, 7.5%, 8%, 8.5%, 9%, 10%, 11%, 12%, 13%, 14%, 15%, or a value falling within a range formed by any two thereof. When the heat shrink ratio h of the separator falls within the above range, the separator exhibits superior high-temperature resistance and is less prone to excessive shrinkage in high-temperature environments, thereby reducing the probability of short-circuiting of the secondary battery caused by shrinkage of the separator, and improving the safety performance of the secondary battery.

In some embodiments of this application, the separator further includes a ceramic layer. The ceramic layer is located between the adhesive layer and the base film. The ceramic layer disposed between the separator and the adhesive layer enhances the thermal stability of the separator, so that the positive electrode plate can still be effectively isolated from the negative electrode plate even when the temperature of the secondary battery rises, thereby reducing the risk of thermal runaway. In addition, the introduced ceramic layer also increases the mechanical strength of the separator, and can reduce the probability of damage to the separator when the secondary battery is subjected to mechanical impact. Therefore, the disposed ceramic layer contributes to improving the safety performance of the secondary battery.

In some embodiments of this application, a total coating amount of the adhesive layer and the ceramic layer is a, 7.7 mg/5000 mm²≤a≤26 mg/5000 mm². For example, the value of a may be 7.7 mg/5000 mm², 8 mg/5000 mm², 9 mg/5000 mm², 10 mg/5000 mm², 11 mg/5000 mm², 12 mg/5000 mm², 13 mg/5000 mm², 14 mg/5000 mm², 15 mg/5000 mm², 16 mg/5000 mm², 17 mg/5000 mm², 18 mg/5000 mm², 19 mg/5000 mm², 20 mg/5000 mm², 21 mg/5000 mm², 22 mg/5000 mm², 23 mg/5000 mm², 24 mg/5000 mm², 25 mg/5000 mm², 26 mg/5000 mm², or a value falling within a range formed by any two thereof. By controlling the total coating amount a of the adhesive layer and the ceramic layer to fall within the above range, this application further improves the thermal stability and mechanical strength of the separator, thereby further improving the safety performance of the secondary battery.

In some embodiments of this application, a thickness of the ceramic layer is d1, 0.5 μm≤d1≤4 μm. A thickness of the adhesive layer is d2, 0.2 μm≤d2≤3 μm. For example, d1 may be 0.5 μm, 1 μm, 1.5 μm, 2 μm, 2.5 μm, 3 μm, 3.5 μm, 4 μm, or a value falling within a range formed by any two thereof. For example, d2 may be 0.2 μm, 0.4 μm, 0.6 μm, 0.8 μm, 1 μm, 1.2 μm, 1.4 μm, 1.6 μm, 1.8 μm, 2 μm, 2.2 μm, 2.4 μm, 2.6 μm, 2.8 μm, 3 μm, or a value falling within a range formed by any two thereof. By controlling d1 and d2 to fall within the above ranges, this application not only improves the thermal stability and mechanical strength of the separator, but also helps control the thickness of the secondary battery to fall within an appropriate range, thereby improving the safety performance of the secondary battery while achieving a desirable energy density. In some embodiments of this application, the adhesive layer further includes a ceramic material. By adding a ceramic material into the adhesive layer, this application improves the thermal stability and mechanical strength of the separator, thereby improving the safety performance of the secondary battery subjected to a temperature rise or mechanical impact. In addition, the ceramic material in the adhesive layer can create voids within the adhesive layer. The voids serve as transport channels of active ions, thereby improving the kinetic performance of the secondary battery.

In some embodiments of this application, the coating amount of the adhesive layer is c, 3 mg/5000 mm²≤c≤12 mg/5000 mm². For example, the value of c may be 3 mg/5000 mm², 3.5 mg/5000 mm², 4 mg/5000 mm², 4.5 mg/5000 mm², 5 mg/5000 mm², 5.5 mg/5000 mm², 6 mg/5000 mm², 6.5 mg/5000 mm², 7 mg/5000 mm², 7.5 mg/5000 mm², 8 mg/5000 mm², 8.5 mg/5000 mm², 9 mg/5000 mm², 9.5 mg/5000 mm², 10 mg/5000 mm², 10.5 mg/5000 mm², 11 mg/5000 mm², 11.5 mg/5000 mm², 12 mg/5000 mm², or a value falling within a range formed by any two thereof. By controlling the value of c to fall within the above range, this application improves thermal stability and mechanical strength of the separator while achieving appropriate adhesiveness of the separator, thereby improving the peel strength between the positive electrode plate and the separator, and consequently improving the cycle performance and safety performance of the secondary battery.

In some embodiments of this application, based on a mass of the adhesive layer, a mass percent w of the ceramic material is 40% to 70%. For example, the value of w may be 40%, 42%, 44%, 46%, 48%, 50%, 52%, 54%, 56%, 58%, 60%, 62%, 64%, 66%, 68%, 70%, or a value falling within a range formed by any two thereof. By controlling the mass percent w of the ceramic material to fall within the above range, this application further balances the adhesiveness, thermal stability, and mechanical strength of the secondary battery, thereby further improving the cycle performance and safety performance of the secondary battery.

In some embodiments of this application, a thickness of the adhesive layer is d3, 1 μm≤d3≤4 μm. For example, d3 may be 1 μm, 1.1 μm, 1.2 μm, 1.3 μm, 1.4 μm, 1.5 μm, 1.6 μm, 1.7 μm, 1.8μ, 1.9 μm, 2μ, 2.1μ, 2.2μ, 2.3 μm, 2.4 μm, 2.5 μm, 2.6 μm, 2.7 μm, 2.8 μm, 2.9 μm, 3 μm, 3.2 μm, 3.4 μm, 3.6 μm, 3.8 μm, 4 μm, or a value falling within a range formed by any two thereof. By controlling d3 to fall within the above range, this application improves the thermal stability and mechanical strength of the separator, and also keeps the thickness of the secondary battery within an appropriate range, thereby improving the safety performance of the secondary battery while achieving a desirable energy density.

In this application, the thickness of the separator is not particularly limited herein, as long as the objectives of this application can be achieved. For example, the thickness of the separator may be 5 μm to 32 μm.

In this application, the thickness of the base film is not particularly limited herein, as long as the objectives of this application can be achieved. For example, the thickness of the base film may be 4 μm to 25 μm.

The positive current collector is not particularly limited herein, as long as the objectives of this application can be achieved. For example, the positive current collector may include aluminum foil, aluminum alloy foil, a composite current collector (for example, an aluminum-carbon composite current collector), or the like.

The positive electrode material layer may further include a conductive agent and a positive electrode binder. The type of the conductive agent is not particularly limited herein, as long as the objectives of this application can be achieved. For example, the conductive agent may include, but is not limited to, at least one of conductive carbon black (Super P), carbon nanotubes (CNTs), carbon fibers, flake graphite, graphene, a metal material, or a conductive polymer. The conductive carbon black may include, but is not limited to, acetylene black or Ketjen black. The carbon nanotubes may include, but are not limited to, single-walled carbon nanotubes and/or multi-walled carbon nanotubes. The carbon fibers may include, but are not limited to, vapor grown carbon fibers (VGCF) and/or carbon nanofibers. The metal material may include, but is not limited to, metal powder and/or metal fibers. Specifically, the metal may include, but is not limited to, at least one of copper, nickel, aluminum, or silver. The conductive polymer may include, but is not limited to, at least one of polyphenylene derivatives, polyaniline, polythiophene, polyacetylene, or polypyrrole.

The positive electrode binder is not particularly limited herein, as long as the objectives of this application can be achieved. For example, the positive electrode binder may include, but is not limited to, at least one of polyacrylic acid, polyacrylic acid sodium, polyacrylic acid potassium, polyacrylic acid lithium, polyimide, polyvinyl alcohol, carboxymethyl cellulose, sodium carboxymethyl cellulose, lithium carboxymethyl cellulose, polyimide, polyamide imide, styrene butadiene rubber, or polyvinylidene difluoride.

The thicknesses of the positive current collector and positive electrode material layer are not particularly limited herein, as long as the objectives of this application can be achieved. For example, the thickness of the positive current collector is 8 μm to 20 μm, and the thickness of the positive electrode material layer is 60 μm to 140 μm.

Optionally, the positive electrode plate may further include a conductive layer. The conductive layer is located between the positive current collector and the positive electrode material layer. The composition of the conductive layer is not particularly limited, and may be a conductive layer commonly used in the art. The conductive layer includes a conductive agent and a positive electrode binder. The conductive agent and the positive electrode binder in the conductive layer are not particularly limited herein. For example, the conductive agent and the positive electrode binder may be at least one of the above conductive agents and the above positive electrode binders.

In this application, the secondary battery further includes a negative electrode plate. The negative electrode plate includes a negative current collector and a negative electrode material layer disposed on at least one surface of the negative current collector. “The negative electrode material layer is disposed on at least one surface of the negative current collector” means that the negative electrode material layer may be disposed on one surface of the negative current collector or on both surfaces of the negative current collector along the thickness direction of the current collector. It is noted that the “surface” here may be the entire surface region of the negative current collector, or a partial surface region of the negative current collector, without being particularly limited herein, as long as the objectives of the application can be achieved.

The negative current collector is not particularly limited herein, as long as the objectives of this application can be achieved. For example, the negative current collector may include copper foil, copper alloy foil, nickel foil, stainless steel foil, titanium foil, foamed nickel, foamed copper, or composite current collector. As an example, the composite current collector may be a lithium-copper composite current collector, a carbon-copper composite current collector, a nickel-copper composite current collector, or a titanium-copper composite current collector.

The negative electrode material layer includes a negative active material. The negative active material is not particularly limited herein, as long as the objectives of this application can be achieved. For example, the negative active material may include, but is not limited to, at least one of natural graphite, artificial graphite, mesocarbon microbeads, hard carbon, soft carbon, silicon, a silicon-carbon composite, Li—Sn alloy, Li—Sn—O alloy, Sn, SnO, SnO₂, spinel-structured lithiated TiO₂—Li₄Ti₅O₁₂, or Li—Al alloy.

In some embodiments of this application, the negative electrode material layer may further include a conductive agent and a negative electrode binder. The types of the conductive agent and the binder are not particularly limited herein, as long as the objectives of this application can be achieved. For example, the conductive agent and the negative electrode binder may be at least one of the above conductive agents and the above positive electrode binders. The mass ratio between the negative active material, the conductive agent, and the negative electrode binder in the negative electrode material layer is not particularly limited herein, and may be selected by a person skilled in the art as actually required, as long as the objectives of this application can be achieved.

The thickness of the negative electrode material layer is not particularly limited herein, as long as the objectives of this application can be achieved. For example, the thickness of the negative electrode material layer is 80 μm to 140 μm.

The thickness of the negative current collector is not particularly limited herein, as long as the objectives of this application can be achieved. For example, the thickness of the negative current collector is 4 μm to 12 μm.

Optionally, the negative electrode plate may further include a conductive layer. The conductive layer is located between the negative current collector and the negative electrode material layer. The constituents of the conductive layer are not particularly limited herein, and the conductive layer may be a conductive layer commonly used in the art. For example, the conductive layer includes a conductive agent and a negative electrode binder. The conductive agent and the negative electrode binder in the conductive layer are not particularly limited herein. For example, the conductive agent and the negative electrode binder may be at least one of the above conductive agents and the above negative electrode binders.

In this application, the secondary battery further includes an electrolyte solution. The electrolyte solution includes a lithium salt and a nonaqueous solvent.

The type of the lithium salt is not particularly limited herein, as long as the objectives of this application can be achieved. For example, the lithium salt may include, but is not limited to, at least one of LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, Li₂SiF₆, lithium bis(oxalato) borate (LiBOB), or lithium difluoroborate. The content of the lithium salt in the electrolyte solution is not particularly limited herein, as long as the objectives of this application can be achieved.

The nonaqueous solvent is not particularly limited herein, as long as the objectives of this application can be achieved. For example, the nonaqueous solvent may include, but is not limited to, at least one of a carbonate ester compound, a carboxylate ester compound, an ether compound, or other organic solvents.

The carbonate ester compound may include, but is not limited to, at least one of a chain carbonate ester compound, a cyclic carbonate ester compound, or a fluorocarbonate ester compound. The chain carbonate ester compound may include, but is not limited to, at least one of dimethyl carbonate (DMC), diethyl carbonate (DEC), dipropyl carbonate (DPC), methyl propyl carbonate (MPC), ethylene propyl carbonate (EPC), or ethyl methyl carbonate (EMC). The cyclic carbonate ester compound may include, but is not limited to, at least one of ethylene carbonate (EC), propylene carbonate (PC), butylene carbonate (BC), or vinyl ethylene carbonate (VEC). The fluorocarbonate ester compound may include, but is not limited to, at least one of fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methyl ethylene, 1-fluoro-1-methyl ethylene carbonate, 1,2-difluoro-1-methyl ethylene carbonate, 1,1,2-trifluoro-2-methyl ethylene carbonate, or trifluoromethyl ethylene carbonate. The carboxylate ester compound may include, but is not limited to, at least one of methyl formate, methyl acetate, ethyl acetate, n-propyl acetate, tert-butyl acetate, methyl propionate, ethyl propionate, propyl propionate, γ-butyrolactone, decanolactone, valerolactone, or caprolactone. The ether compound may include, but is not limited to, at least one of dibutyl ether, tetraglyme, diglyme, 1,2-dimethoxyethane, 1,2-diethoxyethane, 1-ethoxy-1-methoxyethane, 2-methyltetrahydrofuran, or tetrahydrofuran. The above-mentioned other organic solvents may include, but are not limited to, at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate. The mass percent of the nonaqueous solvent in the electrolyte solution is not particularly limited herein, as long as the objectives of this application can be achieved.

The secondary battery further includes a housing. The housing is configured to accommodate a positive electrode plate, a separator, a negative electrode plate, an electrolyte solution, and other components known in the art for use in the secondary battery. The other components are not limited herein. The housing is not particularly limited herein, and may be a housing well-known in the art, as long as the objectives of this application can be achieved. For example, the housing may be a hard housing or a flexible housing. The material of the hard housing may be metal. The type of the metal is not limited herein. The hard housing may be a metallic hard housing known in the art as long as the objectives of this application can be achieved. The flexible housing may be a metallic laminated film such as an aluminum laminated film, a steel laminated film.

The process of preparing the secondary battery of this application is well known to a person skilled in the art, and is not particularly limited herein. For example, the preparation process of the secondary battery may include, but is not limited to, the following steps: stacking the positive electrode plate, the separator, and the negative electrode plate in sequence, performing operations as required such as winding and folding to obtain a jelly-roll electrode assembly, putting the electrode assembly into a housing, injecting the electrolyte solution into the housing, and sealing the housing to obtain a secondary battery. Alternatively, the steps are as follows: stacking the positive electrode plate, the separator, and the negative electrode plate in sequence, and then fixing the four corners of the entire stacked structure by use of adhesive tape to obtain a stacked-type electrode assembly, putting the electrode assembly into a housing, injecting the electrolyte solution into the housing, and sealing the housing to obtain a secondary battery. In addition, an overcurrent protection element, a conductive plate, and the like as required may be placed into a housing, so as to prevent the rise of internal pressure, overcharge, and overdischarge of the secondary battery.

A second aspect of this application provides an electronic device. The electronic device includes the secondary battery disclosed in any one of the preceding embodiments. Therefore, the electronic device provided in this application exhibits good operating performance.

The type of the electronic device is not particularly limited herein, and may be any electronic device known in the prior art. In some embodiments of this application, the types of the electronic device may include, but are not limited to, a laptop computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, lighting appliance, toy, game console, watch, electric tool, flashlight, camera, large household storage battery, lithium-ion capacitor, or the like.

### EMBODIMENTS

The implementations of this application are described below in more detail with reference to some embodiments and comparative embodiments. Various tests and evaluations are performed by the following methods. In addition, unless otherwise specified, the word “parts” means parts by mass, and the symbol “%” means a percentage by mass.

### Test Methods and Devices

### Sampling of a Positive Electrode Plate and a Separator

First, disassembling a lithium-ion battery, taking out a positive electrode plate and a separator, cleaning the positive electrode plate and the separator using dimethyl carbonate (DMC), and then drying the positive electrode plate at 80° C. to obtain a positive electrode plate specimen, and air-drying the separator at room temperature to obtain a separator specimen.

Unless otherwise specified, the following test methods are performed using the positive electrode specimen and separator specimen obtained above.

### Test of Average Particle Diameter

Taking a positive electrode plate specimen. Performing ion beam cross-section polishing on the positive electrode plate specimen along a thickness direction of the specimen to obtain a cross-section of the positive electrode plate, and measuring the cross-section using a scanning electron microscope (SEM). First, finding an interface between the first material layer and the second material layer, where an interface region includes a region extending 5 μm from the interface along a direction from the first material layer to the second material layer and a region extending 5 μm from the interface along a direction from the second material layer to the first material layer. Selecting 10 metal-containing particles from the interface region using an energy dispersive spectrometer (EDS) function of the SEM, measuring circumcircle diameters of the particles separately, and averaging out the measured values to obtain an average diameter D3. Subsequently, selecting 10 particles from a region (a first region) outside the interface region of the first material layer and 10 particles from a region (a second region) outside the interface region of the second material layer using the above method. Measuring circumcircle diameters of the particles separately, and averaging out the measured values to obtain average diameters D1 and D2 respectively.

### Test of Peel Strength

Disassembling a lithium-ion battery, taking out together a positive electrode plate, a separator, and a negative electrode plate bonded together, and detaching the negative electrode plate to obtain a peel strength test specimen. Cutting out a 100 mm×30 mm strip from the specimen. Using a grip of a tensile tester to clamp one end of the positive electrode plate, and pulling the positive electrode plate at 180° to initiate the tensile test. Pulling the positive electrode plate at a uniform speed of 50 mm/min until the positive electrode plate is peeled off from the separator, so as to obtain the peel strength F between the positive electrode plate and the separator.

### Test of Area Fraction (b×100%) of the Adhesive Layer

Taking a separator specimen, and observing the specimen using a scanning electron microscope (SEM). Determining that a region in which sharply defined particles are distributed is an adhesive-layer-coated region in the separator, and denoting a total area of the remaining region without sharply defined particles as S1. Measuring the total area S of the separator using a micrometer. Using SEM image processing software to perform thresholding on the SEM image based on different contrasts, and calculating the area fraction as b×100%=S1/S×100%.

### Test of Specific Surface Area

Scraping powder of the second material layer from the second region, and calcining the powder in a 500° C. air atmosphere for 2 hours to remove the conductive agent, binder, moisture, and impurities from the positive electrode material layer. Measuring the specific surface area of the material layer using a specific surface area analyzer (TriStar II 3020) by means of N₂ adsorption. The second region is determined in a way described in the average particle diameter test method.

### Test of Heat Shrink Ratio

Taking a separator specimen Xᵢ mm×Yᵢ mm, and heating the specimen in a 130° C. oven for 1 hour. Leaving the heated separator to stand statically to cool it down, and then measuring minimum dimensions of the separator in a transverse direction (TD) and a transverse direction (MD) separately, denoted as Xa mm and Ya mm respectively.

$$Calculating the heat shrink ratio in the TD direction as {h}_{TD} = ( {X}_{i} - {X}_{a} ) / {X}_{i} \times 100 \% .$$

$$Calculating the heat shrink ratio in the MD direction as {h}_{MD} = ( {Y}_{i} - {Y}_{a} ) / {Y}_{i} \times 100 \% .$$

Finally, recording the larger value between h_{TD} and h_{TD} as a heat shrink ratio h of the separator.

### Test of Coating Amount

Coating amount a: Taking a separator specimen with an area of 5000 mm², and weighing the specimen to obtain a separator mass n1. Placing the specimen into a container. First, sonicating the specimen at a temperature of 45° C. for 3 hours in water in an ultrasonic instrument with a heating function. Taking out the separator after the separator becomes completely transparent, so as to obtain a base film. Oven-drying the base film and then weighing the base film to obtain a mass m². Calculating the coating amount as: a=(m1−m2) mg/5000 mm².

Subsequently, sonicating the separator specimen at a temperature of 45° C. for 3 hours in an N-methylpyrrolidone (NMP) solvent in an ultrasonic instrument with a heating function if the ceramic layer and adhesive layer on the separator do not peel off after being sonicated in water. Taking out the separator after the separator becomes completely transparent, so as to obtain a base film. Weighing the base film to obtain a mass m2. Calculating the coating amount as: a=(m1−m2) mg/5000 mm².

Coating amount c: Testing the coating amount c in the same way as the test method for the value a described above, and recording the difference between the mass of the separator before ultrasonication and the mass of the separator after ultrasonication as m3, which is the coating amount c.

### Test of Mass Percent w of Ceramic Material

Centrifuging the sonicated solution, oven-drying the solid material obtained by centrifugation, and weighing the solid material to obtain a mass denoted as m4.

$$w = m 4 / m 3 \times 100 \% .$$

### Thickness Measurement

Taking a positive electrode plate specimen, and performing ion beam cross-section polishing on the positive electrode plate specimen along a thickness direction of the specimen to obtain a cross-section of the positive electrode plate, and measuring the cross-section using a scanning electron microscope (SEM). Measuring the thickness of the ceramic layer and the thickness of the adhesive layer separately based on the location of the base film and the morphology of the ceramic layer and the adhesive layer to obtain d1 and d2.

Measuring d3 in the same way as the measurement method described above.

### Test of Cycle Capacity Retention Rate

Charging a lithium-ion battery at a constant current of 1 C at 25° C. until the voltage reaches 4.45 V, and then charging the battery at a constant voltage of 4.45 V until the current drops to 0.05 C, and leaving the battery to stand for 10 minutes. Subsequently, discharging the battery at a constant current of 1 C until the voltage drops to 3.0 V, and leaving the battery to stand for 5 minutes, thereby completing one cycle. Repeating the above steps to complete 1000 cycles. Recording a first-cycle discharge capacity as an initial capacity Q0, and recording the 1000th-cycle discharge capacity of the lithium-ion battery as Q1. Calculating the 1000th-cycle capacity retention rate of the lithium-ion battery using the following formula: cycle capacity retention rate (%)=Q1/Q0×100%.

### Test of Lithium Plating

Disassembling the lithium-ion battery subjected to the above cycle capacity test, and taking a surface of a negative electrode material layer near the winding center in the negative electrode plate in the outermost turn of the lithium-ion battery as an observation interface.

Criteria for determining the degree of lithium plating: If the lithium plating area is 0, it is determined that no lithium plating occurs; if the area fraction of the lithium plating area in the area of the observation interface is less than 5%, it is determined that mild lithium plating occurs; if the area fraction of the lithium plating area in the area of the observation interface is 5% to 10%, it is determined that moderate lithium plating occurs; and if the area fraction of the lithium plating area in the area of the observation interface is greater than 10%, it is determined that severe lithium plating occurs.

This application uses the degree of lithium plating to characterize the safety performance of a lithium-ion battery.

### Test of Critical C-Rate of Lithium Plating

Charging a lithium-ion battery at a constant current of 0.7 C at 25° C. until the voltage reaches 4.45 V, and then charging the battery at a constant voltage of 4.45 V until the current tapers off to 0.05 C. Disassembling the lithium-ion battery, and observing the interfaces of all negative electrode plates of the lithium-ion battery to check if any metallic lithium is deposited. Increasing, if no metallic lithium is deposited, the charge rate in increments of 0.05 C to further charge the battery until metallic lithium is deposited on the surface of the disassembled lithium-ion battery. Recording the last charge rate without lithium plating as a critical C-rate of lithium plating of the lithium-ion battery.

This application uses the critical C-rate of lithium plating to characterize the kinetic performance of a lithium-ion battery. The higher the critical C-rate of lithium plating, the higher the kinetic performance of the lithium-ion battery.

### Nail Penetration Test

Charging the lithium-ion battery at a 0.5 C rate until the voltage reaches 4.45 V, and then charging the battery at a constant voltage until the current tapers off to 0.05 C. Using a 3 mm steel needle to completely penetrate the lithium-ion battery at a speed of 10 cm/s in a direction perpendicular to the maximum surface of the lithium-ion battery. Determining pass of the test if the lithium-ion battery does not catch fire, explode, or emit smoke. For each embodiment or comparative embodiment, 10 lithium-ion batteries are tested. The number of batteries that pass the test is recorded as: number of batteries passing the test/number of batteries tested, such as 9/10 indicating that 9 out of 10 lithium-ion batteries tested have passed the test.

### Test of Energy Density

Measuring the length L, width W, and thickness H of a battery using a three-dimensional scanner.

Charging the lithium-ion battery at a constant current of 0.2 C in a 25° C. environment with a charge-discharge tester until the voltage reaches 4.5 V, and then charging the battery at a constant voltage of 4.5 V until the current drops to a cutoff current 0.05 C, leaving the battery to stand for 10 minutes, and then discharging the battery at a constant current of 0.2 C until the voltage drops to 3 V. Recording the discharge capacity C and a discharge plateau V. Calculating the volumetric energy density of the lithium-ion battery as VED=(C×V)/(L×W×H), in units of Wh/L.

### Embodiment 1-1

### Preparation of a Positive Electrode Plate

Mixing NCM811 as a first positive active material, Super P as a conductive agent, and polyvinylidene fluoride as a binder at a mass ratio of 96:2:2, adding N-methyl-pyrrolidone (NMP) as a solvent to formulate a slurry in which the solid content is 75 wt %, and stirring well with a vacuum mixer to obtain a first material layer slurry. The average particle diameter of the first positive active material is 4 μm.

Mixing lithium cobalt oxide as a second positive active material, Super P as a conductive agent, and polyvinylidene fluoride as a binder at a mass ratio of 96:2:2, adding N-methyl-pyrrolidone (NMP) as a solvent to formulate a slurry in which the solid content is 75 wt %, and stirring well with a vacuum mixer to obtain a second positive electrode material layer slurry. The average particle diameter of the second positive active material is 16 μm.

Applying the first material layer evenly onto one surface of 10 μm-thick positive current collector aluminum foil, and drying the material layer at 120° C. Subsequently, applying the second material layer evenly onto a surface of the first material layer, and drying the material layer at 120° C., so as to obtain a positive electrode plate coated with the first material layer and the second material layer on a single side. The coating weight per unit area of the positive electrode material layer is 327 mg/1540 mm², with the coating weight per unit area of the first material layer being equal to the coating weight per unit area of the second material layer. Subsequently, repeating the above steps on the other surface of the aluminum foil to obtain a positive electrode plate coated with the first material layer and the second material layer on both sides. Drying the electrode plate at 120° C., and cold-pressing it to obtain a positive electrode plate. Cutting the electrode plate and welding a tab to obtain a positive electrode plate of 74 mm×867 mm in size for further use. The thickness of the positive electrode material layer on a single side is 60 μm. Specific parameters are shown in Table 1 to Table 2.

### Preparation of a Negative Electrode Plate

Mixing artificial graphite as a negative active material, styrene-butadiene rubber as a binder, and acetylene black as a conductive agent at a mass ratio of 97.4:1.4:1.2, adding deionized water as a solvent to formulate a slurry in which the solid content is 45 wt %, and stirring well with a vacuum mixer to obtain a negative electrode slurry. Applying the negative electrode slurry evenly onto one surface of 6 μm-thick negative current collector copper foil, and drying the slurry at 120° C. to obtain a negative electrode plate coated with a negative electrode material layer on a single side, where the coating weight of the negative electrode material layer per unit area is 173 mg/1540 mm². Subsequently, repeating the above steps on the other surface of the copper foil to obtain a negative electrode plate coated with the negative electrode material layer on both sides. Drying the electrode plate at 120° C., and then performing cold-pressing, cutting, and tab welding to obtain a negative electrode plate of 78 mm×875 mm in size for future use. The thickness of the negative electrode material layer on a single side is 66.5 μm.

### Preparation of an Electrolyte Solution

Mixing dimethyl carbonate, diethyl carbonate, and ethylene carbonate at a mass ratio of 1:1:1 in an environment in which the water content is less than 10 ppm, and stirring well to obtain an organic solution. Subsequently, adding LiPF₆ as an electrolyte salt into the organic solvent, and stirring well to obtain an electrolyte solution. Based on the mass of the electrolyte solution, the mass percent of the electrolyte salt is 12.5%, and the remainder is the organic solvent.

### Preparation of a Separator

### Preparation of an Adhesive Layer Slurry:

Adhesive layer slurry: Dissolving polyvinylidene fluoride as a separator binder in a solvent NMP to obtain an adhesive layer slurry in which the solid content is 5 wt %.

Using a 5 μm-thick polyethylene base film as a base film of the separator. Applying the adhesive layer slurry onto one surface of the base film, and then oven-drying the slurry. Repeating the above steps on the other surface of the base film to obtain a separator coated with the adhesive layer on both sides. The coating amount of the adhesive layer on a single side is 2 mg/5000 mm², the thickness of the adhesive layer on a single side is 0.5 μm, and the porosity of the separator is 39%. Specific parameters are shown in Table 1 to Table 4.

### Preparation of a Lithium-Ion Battery

Stacking the above-prepared positive electrode plate, separator, and negative electrode plate in sequence such that the separator is located between the positive electrode plate and the negative electrode plate to serve a function of separation, and winding the stacked structure to obtain an electrode assembly. Putting the electrode assembly into an aluminum laminated film package, dehydrating the packaged electrode assembly at 80° C., and then injecting the above-prepared electrolyte solution. Performing steps such as vacuum sealing, static standing, chemical formation, degassing, and edge trimming to obtain a lithium-ion battery. The upper cutoff voltage for the formation is 4.15 V. The formation is performed for a duration of 50 minutes with a pressure of 1.8 MPa at a temperature of 70° C. After formation, the product is left to stand for 2 hours.

### Embodiments 1-2 to 1-16

Identical to Embodiment 1-1 except that the relevant preparation parameters are adjusted according to Table 1.

### Embodiments 1-17 to 1-22

Identical to Embodiment 1-1 except that the relevant preparation parameters are adjusted according to Table 2.

### Embodiment 1-23

Identical to Embodiment 1-1 except that the adhesive layer slurry is prepared according to the following method:

Adhesive layer slurry: Dissolving polyacrylate ester as a separator binder in a water solvent to obtain an adhesive layer slurry in which the solid content is 5 wt %.

### Embodiment 2-1

Identical to Embodiment 1-1 except that the separator and the lithium-ion battery are prepared according to the following methods.

The preparation method of the adhesive layer slurry is identical to that in Embodiment 1-1.

Ceramic layer slurry: Dissolving aluminum oxide as a ceramic material and polyvinylidene fluoride as a binder in a solvent NMP to obtain a ceramic layer slurry in which the solid content is 30 wt %.

Using a 5 μm-thick polyethylene base film as a base film of the separator. Applying the ceramic layer slurry onto one surface of the base film, and then oven-drying the slurry; and applying the adhesive layer slurry onto a surface of the ceramic layer slurry, and then oven-drying the slurry. Subsequently, applying the adhesive layer slurry onto the other surface of the base film to obtain a separator. The coating amount of the ceramic layer is 13.5 mg/5000 mm², the thickness of the ceramic layer is 3 μm. The coating amount of the adhesive layer is 3.5 mg/5000 mm², and the thickness of the adhesive layer is 1.6 μm. The porosity of the separator is 39%. Specific parameters are shown in Table 3.

### Preparation of a Lithium-Ion Battery

Stacking the above-prepared positive electrode plate, separator, and negative electrode plate in sequence such that the separator is located between the positive electrode plate and the negative electrode plate to serve a function of separation, and winding the stacked structure to obtain an electrode assembly. A side, coated with the ceramic layer, of the separator, faces the positive electrode plate. Putting the electrode assembly into an aluminum laminated film package, dehydrating the packaged electrode assembly at 80° C., and then injecting the above-prepared electrolyte solution. Performing steps such as vacuum sealing, static standing, chemical formation, degassing, and edge trimming to obtain a lithium-ion battery. The upper cutoff voltage for the formation is 4.15 V. The formation is performed for a duration of 50 minutes with a pressure of 1.8 MPa at a temperature of 70° C. After formation, the product is left to stand for 2 hours.

### Embodiments 2-2 to 2-10

Identical to Embodiment 2-1 except that the relevant preparation parameters are adjusted according to Table 2.

### Embodiment 2-11

Identical to Embodiment 2-1 except that the adhesive layer slurry is prepared according to the method disclosed in Embodiment 1-23.

### Embodiment 3-1

Identical to Embodiment 1-1 except that the separator is prepared according to the following method.

Adhesive layer slurry: Dissolving polyvinylidene fluoride as a separator binder and aluminum oxide as a ceramic material at a mass ratio of 35:65 in a solvent NMP to obtain an adhesive layer slurry in which the solid content is 15 wt %.

Using a 5 μm-thick polyethylene base film as a base film of the separator. Applying the adhesive layer slurry onto one surface of the base film, and then oven-drying the slurry. The coating amount of the adhesive layer is 5 mg/5000 mm², the thickness of the adhesive layer is 1.5 μm, and the porosity of the separator is 39%. Specific parameters are shown in Table 4.

### Embodiments 3-2 to 3-7

Identical to Embodiment 1-1 except that the relevant preparation parameters are adjusted according to Table 3.

### Comparative Embodiments 1 to 7

Identical to Embodiment 1-1 except that the relevant preparation parameters are adjusted according to Table 1.

TABLE 1

| | | | | | | | | | | | | Test of |
|---|---|---|---|---|---|---|---|---|---|---|---|---|
| | Type of first | | | | | | | | | Cycle | | critical |
| | positive | Type of second | | | | | | | | capacity | Lithium | C-rate of |
| | active | positive active | d1 | d2 | S | D1 | D3 | D2 | F | retention | plating | lithium |
| | material | material | (μm) | (μm) | (m²/g) | (μm) | (μm) | (μm) | (N/m) | rate (%) | test | plating (C) |
| Embodiment 1-1 | NCM811 | Lithium cobalt | 4 | 16 | 0.18 | 4 | 10 | 16 | 9 | 90.0 | No lithium | 1 |
| | | oxide | | | | | | | | | plating | |
| Embodiment 1-2 | NCM811 | Lithium cobalt | 3 | 16 | 0.18 | 3 | 10 | 16 | 9 | 89.5 | No lithium | 1.05 |
| | | oxide | | | | | | | | | plating | |
| Embodiment 1-3 | NCM811 | Lithium cobalt | 5 | 16 | 0.18 | 5 | 10 | 16 | 9 | 90.5 | No lithium | 0.95 |
| | | oxide | | | | | | | | | plating | |
| Embodiment 1-4 | NCM811 | Lithium cobalt | 4 | 9 | 0.30 | 4 | 7 | 9 | 5 | 89.0 | Mild lithium | 1.1 |
| | | oxide | | | | | | | | | plating | |
| Embodiment 1-5 | NCM811 | Lithium cobalt | 4 | 40 | 0.07 | 4 | 22 | 40 | 15 | 89.5 | No lithium | 0.85 |
| | | oxide | | | | | | | | | plating | |
| Embodiment 1-6 | NCM811 | Lithium cobalt | 3 | 9 | 0.30 | 3 | 7 | 9 | 5 | 88.5 | Mild lithium | 1.1 |
| | | oxide | | | | | | | | | plating | |
| Embodiment 1-7 | NCM811 | Lithium cobalt | 5 | 40 | 0.07 | 5 | 22 | 40 | 15 | 89.7 | No lithium | 0.8 |
| | | oxide | | | | | | | | | plating | |
| Embodiment 1-8 | NCM811 | Lithium cobalt | 4 | 12 | 0.24 | 4 | 8 | 12 | 7.5 | 89.6 | Mild lithium | 1.05 |
| | | oxide | | | | | | | | | plating | |
| Embodiment 1-9 | NCM811 | Lithium cobalt | 4 | 20 | 0.14 | 4 | 12 | 20 | 11 | 90.7 | No lithium | 0.95 |
| | | oxide | | | | | | | | | plating | |
| Embodiment 1-10 | NCM811 | Lithium cobalt | 4 | 28 | 0.10 | 4 | 16 | 28 | 13 | 91.2 | No lithium | 0.9 |
| | | oxide | | | | | | | | | plating | |
| Embodiment 1-11 | NCM811 | Lithium cobalt | 4 | 24 | 0.12 | 4 | 14 | 24 | 12 | 91.0 | No lithium | 0.95 |
| | | oxide | | | | | | | | | plating | |
| Embodiment 1-12 | NCM811 | Lithium cobalt | 4 | 14 | 0.20 | 4 | 9 | 14 | 8.5 | 90.0 | No lithium | 1 |
| | | oxide | | | | | | | | | plating | |
| Embodiment 1-13 | NCM811 | Lithium cobalt | 4 | 11 | 0.25 | 4 | 8 | 11 | 7 | 89.7 | Mild lithium | 1.05 |
| | | oxide | | | | | | | | | plating | |
| Embodiment 1-14 | NCM811 | Lithium cobalt | 4 | 8 | 0.35 | 4 | 6 | 8 | 3 | 88.7 | Mild lithium | 1.1 |
| | | oxide | | | | | | | | | plating | |
| Embodiment 1-15 | NCA811 | Lithium manganese | 4 | 16 | 0.55 | 4 | 10 | 16 | 9 | 90.0 | No lithium | 1 |
| | | oxide | | | | | | | | | plating | |
| Embodiment 1-16 | Lithium cobalt | NCM811 | 4 | 16 | 0.18 | 4 | 10 | 16 | 2 | 86.0 | Mild lithium | 1 |
| | oxide | | | | | | | | | | plating | |
| Comparative | NCM811 | Lithium cobalt | 4 | 45 | 0.06 | 4 | 30 | 45 | 20 | 85.0 | No lithium | 0.75 |
| Embodiment 1 | | oxide | | | | | | | | | plating | |
| Comparative | NCM811 | Lithium cobalt | 16 | 16 | 0.18 | 16 | 16 | 16 | 9 | 81.0 | No lithium | 0.8 |
| Embodiment 2 | | oxide | | | | | | | | | plating | |
| Comparative | NCM811 | Lithium cobalt | 6 | 16 | 0.18 | 6 | 11 | 16 | 9 | 88.0 | No lithium | 0.9 |
| Embodiment 3 | | oxide | | | | | | | | | plating | |
| Comparative | NCM811 | Lithium cobalt | 4 | 4 | 0.71 | 4 | 4 | 4 | 0.5 | 80.0 | Severe | 1.2 |
| Embodiment 4 | | oxide | | | | | | | | | lithium | |
| | | | | | | | | | | | plating | |
| Comparative | NCM811 | Lithium cobalt | 16 | 4 | 0.71 | 16 | 10 | 4 | 0.5 | 83.0 | Severe | 1 |
| Embodiment 5 | | oxide | | | | | | | | | lithium | |
| | | | | | | | | | | | plating | |
| Comparative | NCM811 | Lithium cobalt | 2 | 16 | 0.18 | 2 | 9 | 16 | 9 | 82.0 | No lithium | 1 |
| Embodiment 6 | | oxide | | | | | | | | | plating | |
| Comparative | NCM811 | Lithium cobalt | 2 | 20 | 0.14 | 2 | 11 | 20 | 11 | 83.5 | No lithium | 0.95 |
| Embodiment 7 | | oxide | | | | | | | | | plating | |

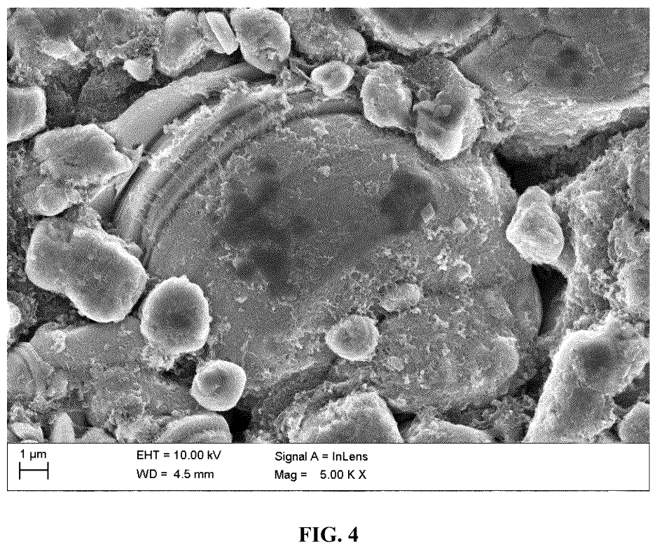

As can be seen from Embodiments 1-1 to 1-16 and Comparative Embodiments 1 to 7, the average particle diameter D1 of active material particles in the first region in the embodiments satisfies 3 μm≤D1≤5 μm, the average particle diameter D2 of active material particles in the second region satisfies 9 μm≤D2≤40 μm, the average particle diameter D3 of active material particles in the interface region satisfies 6 μm≤D3≤22 μm, and the separator includes a base film and adhesive layers. In this way, the peel strength between the second material layer and the separator is relatively high, the cycle capacity retention rate of the resulting lithium-ion battery is relatively high, no severe lithium plating occurs, and the critical C-rate of lithium plating is relatively high. Specifically, FIG. 3 is a scanning electron microscope image of the first material layer according to Embodiment 1-1, and FIG. 4 is a scanning electron microscope image of the second material layer according to Embodiment 1-1. As can be seen from FIG. 3 and FIG. 4, the average particle diameter of the active material in the second material layer is larger than the average particle diameter of the active material in the first material layer. By contrast, in Comparative Embodiment 1, D2 and D3 are excessively large, and therefore, although the peel strength between the second material layer and the separator is relatively high, the cycle capacity retention rate of the resulting lithium-ion battery is relatively low, and the critical C-rate of lithium plating is relatively low. In Comparative Embodiment 2, the average particle diameter of the positive electrode material is not set differently in different regions, and D1 is excessively large. Therefore, although the peel strength between the second material layer and the separator is relatively high, the cycle capacity retention rate of the resulting lithium-ion battery is relatively low, and the critical C-rate of lithium plating is low. In Comparative Embodiment 3, D1 is excessively large. Therefore, although the peel strength between the second material layer and the separator is relatively high, the critical C-rate of lithium plating of the resulting lithium-ion battery is relatively low. In Comparative Embodiment 4, the average particle diameter of the positive electrode material is not set differently in different regions, and D2 and D3 are excessively small. Therefore, the peel strength between the second material layer and the separator is excessively low, the resulting lithium-ion battery exhibits severe lithium plating, and the cycle capacity retention rate is relatively low. In Comparative Embodiment 5, D1 is excessively large and D3 is excessively small. Therefore, the peel strength between the second material layer and the separator is excessively low, the resulting lithium-ion battery exhibits severe lithium plating, and the cycle capacity retention rate is relatively low. In Comparative Embodiments 6 and 7, D1 is excessively small, and therefore, although the peel strength between the second material layer and the separator is relatively high, the cycle capacity retention rate of the resulting lithium-ion battery is relatively low. This demonstrates that the lithium-ion battery that falls within range specified herein achieves relatively high cycle performance, safety performance, and kinetic performance.

The specific surface area S of the second positive active material usually affects the cycle performance, safety performance, and kinetic performance of the lithium-ion battery. As can be seen from Embodiment 1-1 and Embodiments 1-4 to 1-14, when S falls within the range specified herein, the peel strength between the second material layer and the separator is relatively high, the resulting lithium-ion battery exhibits a relatively high cycle capacity retention rate, no severe lithium plating occurs, and the critical C-rate of lithium plating is relatively high. This demonstrates that when the value of S falls within the range specified herein, the resulting lithium-ion battery achieves relatively high cycle performance, safety performance, and kinetic performance.

The types of the first positive active material and the second positive active material usually affect the cycle performance, safety performance, and kinetic performance of the lithium-ion battery. As can be seen from Embodiment 1-1 and Embodiments 1-15 to 1-16, when the types of the first positive active material and the second positive active material fall within the range specified herein, the peel strength between the second material layer and the separator is relatively high, the resulting lithium-ion battery exhibits a relatively high cycle capacity retention rate, no severe lithium plating occurs, and the critical C-rate of lithium plating is relatively high. The specific surface area varies greatly between different positive active materials due to difference in morphology and particle size distribution. For example, the NCM811 used in the second material layer in Embodiments 1-16 affects the peel strength between the second material layer and the separator due to a relatively high residual alkali content. This demonstrates that when the value of S falls within the range specified herein, the resulting lithium-ion battery achieves relatively high cycle performance, safety performance, and kinetic performance.

TABLE 2

| | | Solid content of | | | Cycle capacity | | Test of critical C- |
|---|---|---|---|---|---|---|---|
| | | adhesive layer | b × 100% | F | retention | Lithium plating | rate of lithium |
| | Type of binder | slurry (%) | (%) | (N/m) | rate (%) | test | plating (C) |
| Embodiment 1-1 | Polyvinylidene | 5 | 40 | 9 | 90.0 | No lithium | 1 |
| | fluoride | | | | | plating | |
| Embodiment 1-17 | Polyvinylidene | 1.3 | 10 | 1 | 85.0 | Moderate | 1 |
| | fluoride | | | | | lithium plating | |
| Embodiment 1-18 | Polyvinylidene | 3.8 | 30 | 7 | 89.0 | No lithium | 1 |
| | fluoride | | | | | plating | |
| Embodiment 1-19 | Polyvinylidene | 6.3 | 50 | 9 | 89.5 | No lithium | 1 |
| | fluoride | | | | | plating | |
| Embodiment 1-20 | Polyvinylidene | 8.8 | 70 | 15 | 85.0 | Mild lithium | 0.9 |
| | fluoride | | | | | plating | |
| Embodiment 1-21 | Polyvinylidene | 0.6 | 5 | 0.5 | 83.0 | Moderate | 1 |
| | fluoride | | | | | lithium plating | |
| Embodiment 1-22 | Polyvinylidene | 10 | 80 | 20 | 83.0 | Moderate | 0.8 |
| | fluoride | | | | | lithium plating | |
| Embodiment 1-23 | Acrylate | 5 | 40 | 4 | 89.8 | Mild lithium | 1 |
| | | | | | | plating | |

The area fraction b×100% of the adhesive layer usually affects the cycle performance, safety performance, and kinetic performance of the lithium-ion battery. As can be seen from Embodiment 1-1 and Embodiments 1-17 to 1-22, when b×100% falls within the range specified herein, the peel strength between the second material layer and the separator is relatively high, the resulting lithium-ion battery exhibits a relatively high cycle capacity retention rate, no severe lithium plating occurs, and the critical C-rate of lithium plating is relatively high. This demonstrates that when b×100% falls within the range specified herein, the resulting lithium-ion battery achieves relatively high cycle performance, safety performance, and kinetic performance.

The type of the binder usually affects the cycle performance, safety performance, and kinetic performance of the lithium-ion battery. As can be seen from Embodiments 1-1 and 1-23, when the type of the binder falls within the range specified herein, the peel strength between the second material layer and the separator is relatively high, the resulting lithium-ion battery exhibits a relatively high cycle capacity retention rate, no severe lithium plating occurs, and the critical C-rate of lithium plating is relatively high. This demonstrates that when the type of the binder falls within the range specified herein, the resulting lithium-ion battery achieves relatively high cycle performance, safety performance, and kinetic performance.

TABLE 3

| | a | | | | Capacity | | Nail | Energy |
|---|---|---|---|---|---|---|---|---|
| | (mg/5000 | d1 | d2 | h | retention | Severity of lithium | penetration | density |
| | mm²) | (μm) | (μm) | (%) | rate (%) | plating | test | (Wh/L) |
| Embodiment 1-1 | 4 | / | 1 | 15 | 90 | No lithium plating | 4/10 | 711 |
| Embodiment 2-1 | 17 | 3 | 1.6 | 5 | 92 | No lithium plating | 10/10 | 700 |
| Embodiment 2-2 | 7.7 | 1.5 | 0.2 | 7 | 89 | Moderate lithium plating | 9/10 | 709 |
| Embodiment 2-3 | 26 | 4 | 3 | 2 | 86 | Mild lithium plating | 10/10 | 693 |
| Embodiment 2-4 | 10 | 0.5 | 3 | 9 | 85 | No lithium plating | 6/10 | 703 |
| Embodiment 2-5 | 20 | 4 | 0.2 | 2 | 89 | Moderate lithium plating | 10/10 | 701 |
| Embodiment 2-6 | 6 | 0.3 | 1.6 | 10 | 87 | No lithium plating | 5/10 | 708 |
| Embodiment 2-7 | 27 | 5 | 1.6 | 1 | 90 | Mild lithium plating | 10/10 | 694 |
| Embodiment 2-8 | 14 | 3 | 0.2 | 5 | 90 | Moderate lithium plating | 10/10 | 704 |
| Embodiment 2-9 | 21 | 3 | 3 | 5 | 87 | Mild lithium plating | 10/10 | 696 |
| Embodiment 2-10 | 6 | 1 | 0.5 | 7 | 89 | Moderate lithium plating | 8/10 | 709 |
| Embodiment 2-11 | 17 | 3 | 1.6 | 9 | 91 | No lithium plating | 10/10 | 700 |

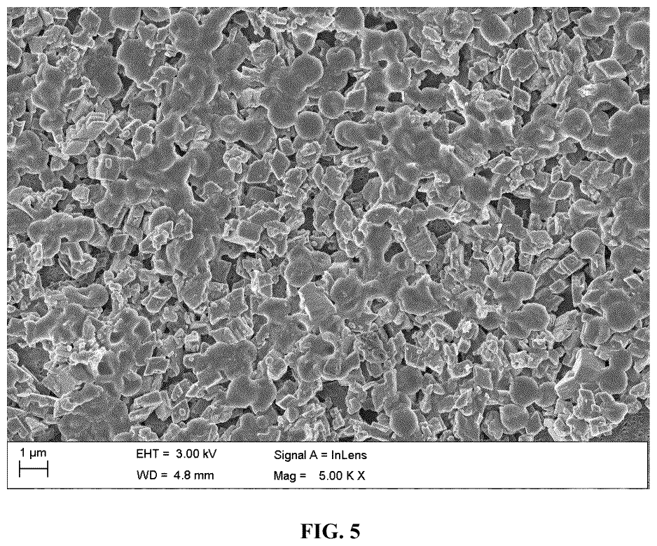

When the separator further includes a ceramic layer, the total coating amount a of the adhesive layer and the ceramic layer usually affect the cycle performance, safety performance, and energy density of the lithium-ion battery. As can be seen from Embodiment 1-1 and Embodiments 2-1 to 2-11, when the value of a falls within the range specified herein, the peel strength between the second material layer and the separator is relatively high, the resulting lithium-ion battery exhibits a relatively high cycle capacity retention rate, no severe lithium plating occurs, the nail penetration test pass rate is relatively high, and the energy density is relatively high. This demonstrates that when the value of a falls within the range specified herein, the resulting lithium-ion battery achieves relatively high cycle performance, safety performance, and energy density. Specifically, as shown in FIG. 5, which is a scanning electron microscope image of an adhesive layer disposed on a surface of the ceramic layer according to Embodiment 2-11, a region in which sharply defined particles are distributed in the figure is a ceramic-layer-coated region, and the remaining region without sharply defined particles is an adhesive-layer-coated region.

The thickness d1 of the ceramic layer usually affects the cycle performance, kinetic performance, safety performance, and energy density of the lithium-ion battery. As can be seen from Embodiment 1-1 and Embodiments 2-1 to 2-10, when the value of d1 falls within the range specified herein, the peel strength between the second material layer and the separator is relatively high, the resulting lithium-ion battery exhibits a relatively high cycle capacity retention rate, no severe lithium plating occurs, the nail penetration test pass rate is relatively high, and the energy density is relatively high. This demonstrates that when the value of d1 falls within the range specified herein, the resulting lithium-ion battery achieves relatively high cycle performance, safety performance, and energy density.

The thickness d2 of the adhesive layer usually affects the cycle performance, kinetic performance, safety performance, and energy density of the lithium-ion battery. As can be seen from Embodiment 1-1 and Embodiments 2-1 to 2-10, when the value of d2 falls within the range specified herein, the peel strength between the second material layer and the separator is relatively high, the resulting lithium-ion battery exhibits a relatively high cycle capacity retention rate, no severe lithium plating occurs, the nail penetration test pass rate is relatively high, and the energy density is relatively high. This demonstrates that when the value of d2 falls within the range specified herein, the resulting lithium-ion battery achieves relatively high cycle performance, safety performance, and energy density.

TABLE 4

| | c | | | | Capacity | | Nail | Energy |
|---|---|---|---|---|---|---|---|---|
| | (mg/5000 | w | d3 | h | retention | Severity of lithium | penetration | density |
| | mm²) | (%) | (μm) | (%) | rate (%) | plating | test | (Wh/L) |
| Embodiment 1-1 | / | / | / | 15 | 90 | No lithium plating | 4/10 | 711 |
| Embodiment 3-1 | 5 | 65 | 1.5 | 6.0 | 88.0 | No lithium plating | 8/10 | 709 |
| Embodiment 3-2 | 3 | 65 | 1 | 7.0 | 87.0 | Mild lithium plating | 6/10 | 711 |
| Embodiment 3-3 | 12 | 65 | 4 | 5.0 | 87.7 | No lithium plating | 9/10 | 702 |
| Embodiment 3-4 | 5 | 40 | 1.4 | 6.3 | 88.0 | No lithium plating | 7/10 | 710 |
| Embodiment 3-5 | 5 | 70 | 1.6 | 5.9 | 88.0 | No lithium plating | 8/10 | 709 |
| Embodiment 3-6 | 5 | 35 | 1.35 | 6.5 | 87.5 | No lithium plating | 6/10 | 710 |
| Embodiment 3-7 | 5 | 75 | 1.65 | 5.5 | 88.3 | Mild lithium plating | 8/10 | 709 |

When the adhesive layer further includes a ceramic material, the coating amount c of the adhesive layer usually affects the cycle performance, kinetic performance, safety performance, and energy density of the lithium-ion battery. As can be seen from Embodiment 1-1 and Embodiments 3-1 to 3-3, when the value of c falls within the range specified herein, the peel strength between the second material layer and the separator is relatively high, the resulting lithium-ion battery exhibits a relatively high cycle capacity retention rate, no severe lithium plating occurs, the nail penetration test pass rate is relatively high, and the energy density is relatively high. This demonstrates that when the value of c falls within the range specified herein, the resulting lithium-ion battery achieves relatively high cycle performance, safety performance, and energy density.

The thickness d3 of the adhesive layer usually affects the cycle performance, kinetic performance, safety performance, and energy density of the lithium-ion battery. As can be seen from Embodiment 1-1 and Embodiments 3-1 to 3-3, when the value of d3 falls within the range specified herein, the peel strength between the second material layer and the separator is relatively high, the resulting lithium-ion battery exhibits a relatively high cycle capacity retention rate, no severe lithium plating occurs, the nail penetration test pass rate is relatively high, and the energy density is relatively high. This demonstrates that when the value of d3 falls within the range specified herein, the resulting lithium-ion battery achieves relatively high cycle performance, safety performance, and energy density.

The mass percent w of the ceramic material usually affects the cycle performance, kinetic performance, safety performance, and energy density of the lithium-ion battery. As can be seen from Embodiment 1-1, Embodiment 3-1, and Embodiments 3-4 to 3-7, when the value of w falls within the range specified herein, the peel strength between the second material layer and the separator is relatively high, the resulting lithium-ion battery exhibits a relatively high cycle capacity retention rate, no severe lithium plating occurs, the nail penetration test pass rate is relatively high, and the energy density is relatively high. This demonstrates that when the value of w falls within the range specified herein, the resulting lithium-ion battery achieves relatively high cycle performance, safety performance, and energy density.

Described above are merely preferred embodiments of this application that are not intended to limit this application. Any modifications, equivalent replacements, improvements, and the like made without departing from the concept and principles of this application still fall within the protection scope of this application.

What is claimed is:

1. A secondary battery, comprising a positive electrode plate and a separator; wherein the positive electrode plate comprises a positive current collector and a positive electrode material layer disposed on at least one surface of the positive current collector; the positive electrode material layer comprises a first material layer and a second material layer; the first material layer is located between the positive current collector and the second material layer;
a contact surface between the first material layer and the second material layer defines an interface; an interface region comprises a region extending 5 μm from the interface along a direction from the first material layer to the second material layer, and a region extending 5 μm from the interface along a direction from the second material layer to the first material layer;
a region other than the interface region in the first material layer is a first region; a region other than the interface region in the second material layer is a second region;
an average particle diameter of active material particles in the first region is D1, 3 μm≤D1≤5 μm; an average particle diameter of active material particles in the second region is D2, 9 μm≤D2≤40 μm; an average particle diameter of active material particles in the interface region is D3, 6 μm≤D3≤22 μm; and
the separator comprises a base film and an adhesive layer; the adhesive layer is disposed on at least one main surface of the base film in a thickness direction of the base film; the adhesive layer is in contact with the second material layer.

2. The secondary battery according to claim 1, wherein peel strength between the second material layer and the separator is F, 1 N/m≤F≤20 N/m.

3. The secondary battery according to claim 2, wherein 3 N/m≤F≤15 N/m.

4. The secondary battery according to claim 1, wherein the adhesive layer comprises one or more selected from the group consisting of polyacrylate, oil-based polyvinylidene fluoride, water-based polyvinylidene fluoride, and poly(vinylidene fluoride-co-hexafluoropropylene).

5. The secondary battery according to claim 1, wherein based on an area of one side main surface of the base film, an area fraction of the adhesive layer is b, 10%≤b×100%≤70%.

6. The secondary battery according to claim 5, wherein 30%≤b×100%≤50%.

7. The secondary battery according to claim 1, wherein the second material layer comprises a second positive active material; and a specific surface area of the second positive active material is S, 0.07 m²/g≤S≤0.3 m²/g.

8. The secondary battery according to claim 7, wherein 0.1 m²/g≤S≤0.25 m²/g.

9. The secondary battery according to claim 8, wherein 0.12 m²/g≤S≤0.2 m²/g.

10. The secondary battery according to claim 1, wherein a heat shrink ratio of the separator is h, 1%≤h≤15%.

11. The secondary battery according to claim 1, wherein the separator further comprises a ceramic layer; the ceramic layer is located between the adhesive layer and the base film; and a total coating amount of the adhesive layer and the ceramic layer is a, 7.7 mg/5000 mm²≤a≤26 mg/5000 mm².

12. The secondary battery according to claim 11, wherein a thickness of the ceramic layer is d1, 0.5 μm≤d1≤4 μm; and a thickness of the adhesive layer is d2, 0.2 μm≤d2≤3 μm.

13. The secondary battery according to claim 1, wherein the adhesive layer further comprises a ceramic material; and a coating amount of the adhesive layer is c, 3 mg/5000 mm²≤c≤12 mg/5000 mm².

14. The secondary battery according to claim 13, wherein based on a mass of the adhesive layer, a mass percent w of the ceramic material is 40% to 70%.

15. The secondary battery according to claim 13, wherein a thickness of the adhesive layer is d3, 1 μm≤d3≤4 μm.

16. The secondary battery according to claim 1, wherein the first material layer comprises a first positive active material, the second material layer comprises a second positive active material; and the first positive active material and the second positive active material each independently comprise one or more selected from the group consisting of lithium cobalt oxide, lithium manganese oxide, lithium nickel cobalt manganese oxide, and lithium nickel cobalt aluminum oxide.

17. The secondary battery according to claim 16, wherein the first positive active material comprises at least one of lithium nickel cobalt manganese oxide or lithium nickel cobalt aluminum oxide; and the second positive active material comprises at least one of lithium cobalt oxide or lithium manganese oxide.

18. The secondary battery according to claim 17, wherein the first positive active material comprises lithium nickel cobalt manganese oxide, and the second positive active material comprises lithium cobalt oxide.

19. An electronic device, comprising a secondary battery; the secondary battery comprises a positive electrode plate and a separator; wherein the positive electrode plate comprises a positive current collector and a positive electrode material layer disposed on at least one surface of the positive current collector; the positive electrode material layer comprises a first material layer and a second material layer; the first material layer is located between the positive current collector and the second material layer;
a contact surface between the first material layer and the second material layer defines an interface; an interface region comprises: a region extending 5 μm from the interface along a direction from the first material layer to the second material layer, and a region extending 5 μm from the interface along a direction from the second material layer to the first material layer;
a region other than the interface region in the first material layer is a first region; a region other than the interface region in the second material layer is a second region;
an average particle diameter of active material particles in the first region is D1, 3 μm≤D1≤5 μm; an average particle diameter of active material particles in the second region is D2, 9 μm≤D2≤40 μm; an average particle diameter of active material particles in the interface region is D3, 6 μm≤D3≤22 μm; and
the separator comprises a base film and an adhesive layer; the adhesive layer is disposed on at least one main surface of the base film in a thickness direction of the base film; the adhesive layer is in contact with the second material layer.

20. The electronic device according to claim 19, wherein the first material layer comprises a first positive active material, the second material layer comprises a second positive active material; the first positive active material comprises at least one of lithium nickel cobalt manganese oxide or lithium nickel cobalt aluminum oxide; and the second positive active material comprises at least one of lithium cobalt oxide or lithium manganese oxide.
